(19) United States
(12) Patent Application Publication
(10) Pub. No.: US 2014/0282390 A1
(43) Pub. Date: Sep. 18, 2014

(54) SYSTEM, METHOD, AND COMPUTER PROGRAM PRODUCT FOR CREATING A COMPUTE CONSTRUCT

(71) Applicant: NVIDIA CORPORATION, Santa Clara, CA (US)

(72) Inventor: Robert Anthony Alfieri, Chapel Hill, NC (US)

(73) Assignee: NVIDIA CORPORATION, Santa Clara, CA (US)

(21) Appl. No.: 13/844,374

(22) Filed: Mar. 15, 2013

(51) Int. Cl. G06F 9/44

(52) U.S. Cl. CPC G06F 8/31
USPC 717/115

(57) ABSTRACT

A system, method, and computer program product are provided for creating a compute construct. In use, a plurality of scripting language statements and a plurality of hardware language statements are identified. Additionally, one or more hardware code components are identified within the plurality of hardware language statements. Additionally, the compute construct is created, utilizing the identified one or more hardware code components and the plurality of scripting language statements.

### FIELD OF THE INVENTION

The present invention relates to hardware designs, and more particularly to hardware design components and their implementation.

### BACKGROUND

Hardware design and verification are important aspects of the hardware creation process. For example, a hardware description language may be used to model and verify circuit designs. However, current techniques for designing hardware have been associated with various limitations.

For example, validation and verification may comprise a large portion of a hardware design schedule utilizing current hardware description languages. Additionally, flow control and other protocol logic may not be addressed by current hardware description languages during the hardware design process. Also, scripting languages may be used separately from hardware description languages, which may result in multiple levels of parsing and complexity. There is thus a need for addressing these and/or other issues associated with the prior art.

### SUMMARY

A system, method, and computer program product are provided for creating a compute construct. In use, a plurality of scripting language statements and a plurality of hardware language statements are identified. Additionally, one or more hardware code components are identified within the plurality of hardware language statements. Additionally, the compute construct is created, utilizing the identified one or more hardware code components and the plurality of scripting language statements.

### BRIEF DESCRIPTION OF THE DRAWINGS

FIG. 1 shows a method for creating a compute construct, in accordance with one embodiment.

FIG. 2 shows a method for incorporating a compute construct into an integrated circuit design, in accordance with another embodiment.

FIG. 3 shows an exemplary hardware design environment, in accordance with one embodiment.

FIG. 4 illustrates an exemplary system in which the various architecture and/or functionality of the various previous embodiments may be implemented.

### DETAILED DESCRIPTION

FIG. 1 shows a method 100 for creating a compute construct, in accordance with one embodiment. As shown in operation 102, a plurality of scripting language statements and a plurality of hardware language statements are identified. In one embodiment, plurality of scripting language statements may include a plurality of statements made in a scripting language (e.g., a dynamic programming language such as Perl, etc.). In another embodiment, the plurality of hardware language statements may include a plurality of statements made in a hardware language (e.g., a language used to model electronic systems, etc.).

Additionally, in one embodiment, the plurality of scripting language statements and the plurality of hardware language statements may be identified within a code block (e.g., a code block associated with the development of a compute construct, etc.). For example, a code block may be provided to a user, and the plurality of scripting language statements and the plurality of hardware language statements may be included by the user within the code block provided to the user. In another embodiment, the plurality of scripting language statements and the plurality of hardware language statements may be included within the code block such that the statements are implemented during simulation or synthesis. In yet another embodiment, the plurality of scripting language statements may be interspersed with the plurality of hardware language statements.

Further, as shown in operation 104, one or more hardware code components are identified within the plurality of hardware language statements. In one embodiment, the one or more hardware code components may be identified for inclusion within a compute construct. In another embodiment, the one or more hardware code components may be identified from a plurality of supported hardware code components.

For example, each of the plurality of hardware code components may include hardware code (e.g., hardware description language code, etc.) that is implemented during a hardware simulation, at the time of a hardware build, etc. In another embodiment, the plurality of hardware code components may be created and stored, as well as associated with one or more operations to be performed (e.g., during a hardware simulation, at the time of a hardware build, etc.).

Additionally, in one embodiment, the one or more hardware code components may include one or more hardware functions (e.g., one or more functions operable within a compute construct, etc.). For example, the one or more hardware code components may include a Curr_Ins( ) function that retrieves all input data flows for the compute construct as an array. In another example, the one or more hardware code components may include a Curr_Outs( ) function that retrieves all output data flows for the compute construct as an array. In yet another example, the one or more hardware code components may include a Curr_State( ) function that retrieves a state data flow for the compute construct.

Further, in one embodiment, the one or more hardware code components may include one or more hardware functions for interrogating data flows from inside of a code block. For example, the one or more hardware code components may include a Valid( ) function that determines whether an input data flow for the compute construct has a valid input. In another example, the one or more hardware code components may include a Ready( ) function that determines whether the output data flow for the compute construct can accept new output. In yet another example, the one or more hardware code components may include a Status( ) function that determines a status of the output data flow for the compute construct. In still another example, the one or more hardware code components may include a Transferred( ) function that tests whether an output data flow for the compute construct is transferring out of the compute construct for a particular cycle.

Further still, in one embodiment, the one or more hardware code components may include one or more hardware statements (e.g., one or more statements operable within the compute construct). For example, the one or more hardware code components may include a Stall statement that manually stalls an input data flow for the compute construct for one cycle. In another example, the one or more hardware code components may include an If, Then statement that conditionally performs one or more actions within the compute construct. In yet another example, the one or more hardware code components may include a Given statement that conditionally performs one or more actions within the compute construct.

Also, in one example, the one or more hardware code components may include one or more blocking statements (e.g., looping statements, control flow statements, etc.) that allow one or more actions to be performed within the compute construct based on a given Boolean condition. In another example, the one or more hardware code components may include one or more statements that trigger a random number generator. In yet another example, the one or more hardware code components may include an Assert statement that stops a hardware design simulation if a Boolean expression is met within the compute construct. In still another example, the one or more hardware code components may include a Printf statement that outputs one or more strings from the compute construct during a hardware design simulation.

Additionally, in one embodiment, the one or more hardware code components may include one or more hardware operators (e.g., one or more operators operable within the compute construct). For example, the one or more hardware code components may include one or more assignment operators, such as a combinational assignment operator, a latched combinational assignment operator, a non-blocking assignment operator, etc. In another example, the one or more hardware code components may include one or more bitslice operators, one or more index operators, etc. In still another example, the one or more hardware code components may include one or more unary operators, one or more binary operators, one or more N-ary operators, etc.

Additionally, as shown in operation 106, the compute construct is created, utilizing the identified one or more hardware code components and the plurality of scripting language statements. In one embodiment, the compute construct may include an entity (e.g., a module, etc.), implemented as part of a hardware description language, that receives one or more data flows as input, where each data flow may represent a flow of data. For example, each data flow may represent a flow of data through a hardware design. In another embodiment, each data flow may include one or more groups of signals. For example, each data flow may include one or more groups of signals including implicit flow control signals. In yet another embodiment, each data flow may be associated with one or more interfaces. For example, each data flow may be associated with one or more interfaces of a hardware design.

Also, in one embodiment, the compute construct may be located in a database. In yet another embodiment, the compute construct may perform one or more operations based on an input data flow or flows. In another example, the compute construct may perform one or more data steering and storage operations, utilizing an input data flow.

Furthermore, in one embodiment, the compute construct may create one or more output data flows, based on the one or more input data flows. In another embodiment, the one or more output data flows may be input into one or more additional constructs. For example, the one or more output data flows may be input into one or more compute constructs, one or more control constructs (e.g., one or more constructs built into the hardware description language, etc.). In yet another embodiment, the compute construct may include one or more parameters. For example, the compute construct may include a name parameter that may indicate a name for the compute construct. In another example, the compute construct may include a comment parameter that may provide a textual comment that may appear in a debugger when debugging a design.

In yet another example, the compute construct may include a parameter that corresponds to an interface protocol. In one embodiment, the interface protocol may include a communications protocol associated with a particular interface. In another embodiment, the communications protocol may include one or more formats for communicating data utilizing the interface, one or more rules for communicating data utilizing the interface, a syntax used when communicating data utilizing the interface, semantics used when communicating data utilizing the interface, synchronization methods used when communicating data utilizing the interface, etc. In one example, the compute construct may include a stallable parameter that may indicate whether automatic flow control is to be performed within the compute construct.

Further still, in one example, the compute construct may include a parameter used to specify a depth of an output queue (e.g., a first in, first out (FIFO) queue, etc.) for each output data flow of the compute construct. In another example, the compute construct may include a parameter that causes an output data flow of the compute construct to be registered out. In yet another example, the compute construct may include a parameter that causes a ready signal of an output data flow of the compute construct to be registered in and an associated skid flop row to be added.

Also, in one embodiment, creating the compute construct utilizing the identified one or more hardware code components and the plurality of scripting language statements may include incorporating the identified one or more hardware code components within the compute construct, such that the computations dictated by the one or more hardware code components may be performed by the compute construct when the compute construct is implemented (e.g., when the compute construct is implemented within a hardware design, etc.). In this way, the compute construct may be created utilizing one or more hardware code components identified within a general-purpose code block of a graphical user interface (GUI).

Additionally, in another embodiment, a hardware design may be created, utilizing an identified data flow and the created compute construct. In one embodiment, the hardware design may include a circuit design. For example, the hardware design may include an integrated circuit design, a digital circuit design, an analog circuit design, a mixed-signal circuit design, etc. In another embodiment, the hardware design may be created utilizing the hardware description language. For example, creating the hardware design may include initiating a new hardware design and saving the new hardware design into a database, utilizing the hardware description language. In yet another embodiment, both the data flow and the created compute construct may be included within the hardware design.

Further still, in one embodiment, creating the hardware design may include activating the data flow. For example, the data flow may be inactive while it is being constructed and modified, and the data flow may subsequently be made active (e.g., by passing the data flow to an activation function utilizing the hardware description language, etc.). In another embodiment, creating the hardware design may include inputting the activated data flow into the construct. For example, the activated data flow may be designated as an input of the construct within the hardware design, utilizing the hardware description language. In this way, the created compute construct may perform one or more operations, utilizing the input data flow, and may create one or more additional output data flows, utilizing the input data flow.

Also, in one embodiment, the data flow may be analyzed within the created compute construct. For example, the data flow may be analyzed during the performance of one or more actions by the created compute construct, and execution of the hardware design may be halted immediately if an error is discovered during the analysis. In this way, errors within the hardware design may be determined immediately and may not be propagated during the execution of the hardware design, until the end of hardware construction, or during the running of a suspicious language flagging program (e.g., a lint program) on the hardware construction. In another embodiment, the created compute construct may analyze the data flow input to the construct and determine whether the data flow is an output data flow from another construct or a deferred output (e.g., a data flow that is a primary design input, a data flow that will be later connected to an output of a construct, etc.). In this way, it may be confirmed that the input data flow is an active output.

In addition, in one embodiment, the created compute construct may interrogate the data flow utilizing one or more introspection methods. For example, the created compute construct may utilize one or more introspection methods to obtain field names within the data flow, one or more widths associated with the data flow, etc. In another embodiment, all clocking may be handled implicitly within the hardware design. For example, a plurality of levels of clock gating may be generated automatically and may be supported by the hardware design language. In this way, manual implementation of clock gating may be avoided.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 2 shows a method 200 for incorporating a compute construct into an integrated circuit design, in accordance with one embodiment. As an option, the method 200 may be carried out in the context of the functionality of FIG. 1. Of course, however, the method 200 may be implemented in any desired environment. It should also be noted that the aforementioned definitions may apply during the present description.

As shown in operation 202, an integrated circuit design is created, utilizing a hardware description language embedded in a scripting language. In one embodiment, the integrated circuit design may be created in response to the receipt of one or more instructions from a user. For example, a description of the integrated circuit design utilizing both the hardware description language and the scripting language may be received from the user, and may be used to create the integrated circuit design. In another embodiment, the integrated circuit design may be saved to a database or hard drive after the integrated circuit design is created. In yet another embodiment, the integrated circuit design may be created in the hardware description language. In still another embodiment, the integrated circuit design may be created utilizing a design create construct. See, for example, U.S. patent application Ser. No. ______ (Attorney Docket No. NVIDP800/DU-12-0790), filed Mar. 15, 2013, which is hereby incorporated by reference in its entirety, and which describes examples of creating an integrated circuit design.

Further, as shown in operation 204, one or more data flows are created in association with the integrated circuit design. In one embodiment, each of the one or more data flows may represent a flow of data through the integrated circuit design and may be implemented as instances of a data type utilizing a scripting language (e.g., Perl, etc.). For example, each data flow may be implemented in Perl as a formal object class. In another embodiment, one or more data flows may be associated with a single interface. In yet another embodiment, one or more data flows may be associated with multiple interfaces, and each of these data flows may be called superflows. For example, superflows may allow the passing of multiple interfaces utilizing one variable.

Further still, in one embodiment, each of the one or more data flows may have an arbitrary hierarchy. In another embodiment, each node in the hierarchy may have alphanumeric names or numeric names. In yet another embodiment, the creation of the one or more data flows may be tied into array and hash structures of the scripting language. For example, Verilog® literals may be used and may be automatically converted into constant data flows by a preparser before the scripting language sees them.

Also, in one embodiment, once created, each of the one or more data flows may look like hashes to scripting code. In this way, the data flows may fit well into the scripting language's way of performing operations, and may avoid impedance mismatches. In another embodiment, the one or more data flows may be created in the hardware description language (e.g., Verilog®, etc.). See, for example, U.S. patent application Ser. No. ______ (Attorney Docket No. NVIDP800/DU-12-0790), filed Mar. 15, 2013, which is hereby incorporated by reference in its entirety, and which describes examples of creating one or more data flows.

Additionally, as shown in operation 206, a compute construct is created, utilizing identified hardware code components. In one embodiment, the hardware code components may be identified in response to their inclusion within a provided general-purpose code block from one or more entities (e.g., users, etc.), where the general-purpose code block may be provided by a system that receives the hardware code. In another embodiment, the code for the compute construct may be supplied in the form of an inline anonymous scripting language function, but may also be a separately declared, named subroutine whose “reference” is passed into the compute construct. The former may ensure that only the compute construct can “see” the hardware code. In yet another embodiment, for each set of input interface flows (e.g., in superflows, etc.), the compute construct may call the code block subroutine, passing as parameters the input and output interface flows, as well as any declared State registers and rams. In another embodiment, the compute construct may be identified as Compute( ).

Further, in one embodiment, the identified hardware code components may intersperse any combination of scripting-language statements (e.g., if, for, etc.) and hardware description language statements and functions. In another embodiment, to avoid conflicts, the hardware description language statements and functions may have identifiers that start with a capital letter to indicate that they are occurring at simulation time, synthesis time, etc.

Further still, in one embodiment, the identified hardware code components may be inserted into a general purpose code block and may represent one cycle of execution. In another embodiment, the general purpose code block may include an anonymous Perl subroutine that may be called by the compute construct to elaborate provided hardware code at build time. In yet another embodiment, the compute construct may pass one or more input data flows and output data flows as arguments.

Also, in one embodiment, the hardware code components may include one or more hardware functions. For example, the hardware code components may include a Curr_Ins( ) hardware function that retrieves all input data flows as an array, a Curr_Outs( ) hardware function that retrieves all output data flows, and a Curr_State( ) hardware function that retrieves the state flow. In another embodiment, the Curr_Ins( ) hardware function and the Curr_Outs( ) hardware function may return anonymous arrays, and the Curr_State( ) hardware function may return a root of the State hierarchy flow.

Further, in one embodiment, the hardware code components may include one or more hardware functions for interrogating data flows from inside the code block. For example, $In_Flow->Valid( ) may return 1 if the input data flow has valid input. Additionally, $Out_Flow->Ready( ) may return 1 if the output data flow can accept new output. This check may occur using the innermost ready signal before any out_fifo or out_reg. Further, $Out_Flow->Status( ) may be used to get the IDLE, STALLED, ACTIVE, or other status of the output, including any FIFO or out_reg. Further still, $Out_Flow->Transferred( ) may be used to test if output is transferring out of the construct this cycle (or previous cycle if out_rdy_reg is in effect).

Table 1 illustrates exemplary options associated with the hardware code, in accordance with one embodiment. Of course, it should be noted that the exemplary options shown in Table 1 are set forth for illustrative purposes only, and thus should not be construed as limiting in any manner.

TABLE 1

| Option | Type | Default | Description |
|---|---|---|---|
| name | id | required | name of generated module |
| comment | string | undef | optional comment to display in the |
| | | | debugger (highly recommended) |
| clk | id | global default | clock to use for this construct |
| Others | array_of_flow | undef | optional array of other input flows |
| Out | flow_or_array | undef | specification of single output iflow; if |
| | | | the spec is an array, then its contents |
| | | | can are passed to Hier( ); if the spec is |
| | | | a flow, then it will be passed to |
| | | | Clone( ) |
| Outs | array of | undef | same as Out, except an array of one or |
| | flow_or_array | | more specifications, each representing |
| | | | one output iflow. |
| | | | Note: If neither Out nor Outs is set, |
| | | | then the Compute( ) has no output |
| | | | flows and returns ‘undef’. |
| State | flow_or_array | undef | optional state registers; when an array |
| | | | is supplied, the contents of the array |
| | | | are passed to Hier( ); when a flow is |
| | | | supplied, then the flow must be |
| | | | hierarchical and it will be passed to |
| | | | Clone( ) |
| | | | Add_State name => flow_template; |
| | | | may also be used from inside the code |
| | | | block to incrementally add to State. |
| | | | multiple name => template pairs may |
| | | | be passed. |
| stallable | 0 or 1 | global default | Controls whether the construct is |
| | | | stallable |
| out_reg | int_or_array_of_int | [global | single 0 or 1, OR array of 0 or 1 |
| | | default, . . .] | indicating whether the corresponding |
| | | | output iflow is registered out; if an int |
| | | | is supplied, then all output iflows will |
| | | | have that value for their out_reg |
| out_separate | int | 1 | indicates that the output is a separate |
| | | | list of flows (default value of 1) or a |
| | | | superflow (0) |
| out_rdy_reg | int_or_array_of_int | [global | single 0 or 1, OR array of 0 or 1 |
| | | default, . . .] | indicating whether the corresponding |
| | | | output iflow's rdy signal is registered |
| | | | in; causes a skid flip-flop to be added |
| | | | even if out_reg = 0; if an int is |
| | | | supplied, then all output iflows will |
| | | | have that value for their out_rdy_reg |
| out_fifo | fifospec_or_array_of_fifospec | [0, 0, . . .] | single fifo spec, OR array of fifo |
| | | | specs, which are currently limited to a |
| | | | simple int representing depth of the |
| | | | fifo for the corresponding output |
| | | | iflow; out_reg and out_rdy_reg flip- |
| | | | flops are after the fifo; if a fifospec is |
| | | | supplied then all output iflows will |
| | | | have that value for their out_fifo |
| code | code | required | the code block (anonymous |
| | | | subroutine) that holds your hardware |
| | | | code; the Compute( ) calls this code, |
| | | | passing as arguments the input flows, |
| | | | output flows, and state - in that order |
| external_module | string | undef | If code is not specified, the name of |
| | | | some external module that holds the |
| | | | code may be specified. |

As shown in Table 1, the hardware code components may include one or more state registers. For example, the state register “State” may include an array of field names, each referring to a flow construction of arbitrary complexity. A state register may be thought of as both an input and output data flow with named fields. In another embodiment, all state flows may be implemented using flip-flops, but they may also contain an Array( ) of subflow, which may be implemented as rams. When superflows are involved, the compute construct may create a separate copy of the state register for each set of interface flows.

Additionally, in one embodiment, State variables may be assigned using <== (no reset), <0= (reset to 0), and <1= (reset to all 1's). In another embodiment, new State variables may be added from inside the code block using Add_State name=>flow_template, where each flow_template is anything that may be passed to Clone( ), such as a leaf width, Hier( ), Hier_N( ), etc. In another embodiment, arbitrary reset values may be assigned using Assign $XXX, <arbitrary reset value>, <post-reset-value>. In yet another embodiment, RAM state may be handled by cIRam instantiations outside of compute constructs, but the RAM write, read, and rdat flows may be fed into the compute construct. In still another embodiment, if any bit in an output iflow or State variable is assigned the same cycle by multiple places in the hardware code found in the code block, an assertion may fire during the simulation using the compute construct. An assertion firing means that a condition specified by the assertion is true and further action specified by the assertion may be taken. In one example, a printf may be executed when an assertion fires.

Further, in one embodiment, an assertion may be compiled into the logic when the logic is run on an emulator of FPGA. For example, when an assertion fires, all clocks may be stopped so as to capture the state of flops and rams as soon as possible. In another embodiment, user-specified assertions may be allowed to carry forward to the hardware and stop the clocks in the same way, so that flops and rams may be scanned out. In yet another embodiment, X's in data packets and State may be allowed. In another embodiment, X's may not implicitly propagate to valid or ready signals. In this way, if the determination of whether to send a new output packet is based on an X, this scenario may cause an assertion to fire during a simulation using the compute construct.

Further still, in one embodiment, if stallable is 1, then the compute construct may handle all flow control in and out of the compute construct automatically according to an interface protocol. In another embodiment, if any output iflow is stalled (e.g., according to an innermost rdy signal, etc.), then all input iflows may be stalled and all State and Out assignments may be disabled. In yet another embodiment, if stallable is 0, then the compute construct may cause an assertion to fire if a new output packet is written for an output iflow that is stalled according to the innermost rdy signal. However, the compute construct may still use $Out->Ready( ) to test the innermost rdy signal of the output iflow and then may Stall the input iflows.

Also, in one embodiment, the hardware code components may include a validation function. For example, the hardware code components may test if an input iflow has valid data using $In->Valid( ). In another embodiment, the hardware code components may create an output packet over a particular output iflow by assigning to any part of that output iflow using the <== assignment operator. Any output field not assigned may contain undefined values.

Additionally, in one embodiment, if one or more input and output data flows for the compute construct have more than one iflow (rare), then the hardware code components may be called back for each set of iflows. More specifically, the logic and State for the compute construct may be elaborated or instantiated once for each set of iflows. In another embodiment, a Curr_Set( ) function may return the index of the set being processed by the current invocation of the code block. In yet another embodiment, this index may include a constant value (e.g., a constant Perl integer value, etc.).

Further, in one embodiment, a debugger may show all compute construct inputs, outputs, and state registers. For example, the debugger may show a stripped-down digest of all the code block statements along with their Perl names and values in a waveform window.

Table 2 illustrates exemplary hardware code within a Compute( ) construct, in accordance with one embodiment. Of course, it should be noted that the exemplary hardware code shown in Table 2 is set forth for illustrative purposes only, and thus should not be construed as limiting in any manner.

TABLE 2
my $Input = aFlow

−>Hier( a => 32, b => 32 )
−>Defer_Output( );

my $Output = $Input−>Compute(

name => “NV_compute_basic_transformation”,
Out => [result => 33],
code => sub
{

my( $In, $Out ) = @_; # these names are shorthands for $Input
and $Output
If $In−>Valid( ) Then

$Out−>{result} <== $In−>{a} + $In−>{b};

Endif
$In−>print( “In” );
$Out−>print( “Out” );

}

);

Table 3 illustrates the results of receiving and implementing the exemplary hardware code of Table 2 inside a code block of the Compute( ) construct, in accordance with one embodiment. Of course, it should be noted that the exemplary results shown in Table 3 are set forth for illustrative purposes only, and thus should not be construed as limiting in any manner.

TABLE 3

In => (iflow)

a => 32
b => 32

Out => (iflow)

result => 33

As shown in Table 3, the output is the sum of the two input values a and b.

Table 4 illustrates exemplary hardware code utilizing State variables within a Compute( ) construct, in accordance with one embodiment. Of course, it should be noted that the exemplary hardware code shown in Table 4 is set forth for illustrative purposes only, and thus should not be construed as limiting in any manner.

TABLE 4
my $In = aFlow

−>Hier( n => 32 )
−>Defer_Output( );

my $Out = $In−>Compute(

name => “NV_compute_state_registers”,
Out => [max_so_far => 32],
State => [seen_any => 1, max => 32],
out_reg => 1,
code => sub
{

my( $In, $Out, $S ) = @_;
If $In−>Valid( ) Then

my $Use_Previous = $S−>{seen_any} &&
($S−>{max} >= $In−>{n});
$Out−>{max_so_far} <== $Use_Previous ? $S−>{max}
: $In−>{n};
$S−>{seen_any] <0= 1;
If !$Use_Previous Then

$S−>{max} <== $In−>{n};

Endif

Endif
$In−>print( “In” );
$Out−>print( “Out” );
$S−>print( “State” );

}

);

As shown in Table 4, a finite state machine (FSM) keeps track of the maximum value seen so far and always outputs that value. Additionally, the command “<0=” is used for $S->{seen_any} to make sure it gets reset to 0.

Table 5 illustrates the results of receiving and implementing the exemplary hardware code of Table 4 inside a code block of the Compute( ) construct, in accordance with one embodiment. Of course, it should be noted that the exemplary results shown in Table 5 are set forth for illustrative purposes only, and thus should not be construed as limiting in any manner.

TABLE 5

In => (iflow)

n => 32

Out => (iflow)

max_so_far => 32

State =>

seen_any => 1
max => 32

Table 6 illustrates exemplary hardware code utilizing multiple inputs and outputs as well as a null output within a Compute( ) construct, in accordance with one embodiment. Of course, it should be noted that the exemplary hardware code shown in Table 6 is set forth for illustrative purposes only, and thus should not be construed as limiting in any manner.

TABLE 6
my $In0 = aFlow

−>Hier( n => 32 )
−>Defer_Output( );

my $In1 = aFlow

−>Hier( n => 32 )
−>Defer_Output( );

my( $Out0, $Out1, $Out2 ) = $In0−>Compute(

name => “NV_compute_multiple_ins_and_outs”,
Others => [$In1],
Outs => [ [max => 32],

[which => 1],
[ ] ],

out_reg => [1, 0, 0],
out_fifo => [4, 0, 0],
code => sub
{

my( $In0, $In1, $Out0, $Out1, $Out2 ) = @_; # no state in this

case, would occur last

#----------------------------------------------------------------------------
# wait for both inputs to arrive then pick the max between the
two and
# indicate on $Out1 which was chosen.
#----------------------------------------------------------------------------
If $In0−>Valid( ) && $In1−>Valid( ) Then

my $Use1 = $In1−>{n} > $In0−>{n};
$Out0−>{max} <== $Use1 ? $In1−>{n} : $In0−>{n};
$Out1−>{which} <== $Use1;
If $Use1 Then
Null $Out2;
Endif

Else

#-----------------------------------------------------------------------
# stall an input if one arrived, and the other didn't
#-----------------------------------------------------------------------
Stall $In0;
Stall $In1;

Endif
$In0−>print( “In0” );
$In1−>print( “In1” );
$Out0−>print( “Out0” );
$Out1−>print( “Out1” );
$Out2−>print( “Out2” );

}

);

As shown in Table 6, 2 input iflows and 3 output iflows are provided. The first output iflow also has a 4-deep fifo followed by an out reg. The second output iflow has no output registering or fifo. The third output iflow is empty. The Compute( ) construct is waiting for both inputs to arrive, then determining which has the larger value. Out0 gets the max value. Out1 gets the index of the input iflow with the larger. An empty packet (Null) is sent on Out2 when In1 has the larger value

Table 7 illustrates the results of receiving and implementing the exemplary hardware code of Table 6 inside a code block of the Compute( ) construct, in accordance with one embodiment. Of course, it should be noted that the exemplary results shown in Table 7 are set forth for illustrative purposes only, and thus should not be construed as limiting in any manner.

TABLE 7

In0 => (iflow)

n => 32

In1 => (iflow)

n => 32

Out0 => (iflow)

max => 32

Out1 => (iflow)

which => 1

Out2 => (iflow)

Table 8 illustrates exemplary hardware code utilizing hardware functions within a Compute( ) construct, in accordance with one embodiment. Of course, it should be noted that the exemplary hardware code shown in Table 8 is set forth for illustrative purposes only, and thus should not be construed as limiting in any manner.

TABLE 8
my $In0 = aFlow

−>Hier( n => 32 )
−>Defer_Output( );

my $In1 = aFlow

−>Hier( n => 32 )
−>Defer_Output( );

my( $Out0, $Out1, $Out2 ) = $In0−>Compute(

name => “NV_compute_multiple_ins_and_outs2”,
Others => [$In1],
Outs => [ [max => 32],

[which => 1],
[ ] ],

State => [last_max => 32],
out_reg => [1, 0, 0],
out_fifo => [4, 0, 0],
code => sub
{

#----------------------------------------------------------------------------
# Alternate way to get to ins, outs, and state.
# This is useful when there are many ins and/or outs.
#----------------------------------------------------------------------------
my $Ins = Curr_Ins( ); # anonymous array
my $Outs = Curr_Outs( ); # anonymous array
my $S = Curr_State( );
#----------------------------------------------------------------------------
# wait for all inputs to arrive
# wait for both inputs to arrive then pick the max between the
two and
# indicate on $Outs−>[1] which was chosen.
#----------------------------------------------------------------------------
If $Ins−>[0]−>Valid( ) && $Ins−>[1]−>Valid( ) Then

my $Use1 = $Ins−>[1]−>{n} > $Ins−>[0]−>{n};
$Outs−>[0]−>{max} <== $Use1 ? $Ins−>[1]−>{n} :
$Ins−>[0]−>{n};
$Outs−>[1]−>{which} <== $Use1;
$S−>{last_max} <== $Ins−>[0]−>{n}; # non-sensical
If $Use1 Then
Null $Outs−>[2];
Endif

Else

#-----------------------------------------------------------------------
# stall an input if one arrived and the other didn't
#-----------------------------------------------------------------------
Stall $Ins−>[0];
Stall $Ins−>[1];

Endif
$Ins−>[0]−>print( “Ins−>[0]” );
$Ins−>[1]−>print( “Ins−>[1]” );
$Outs−>[0]−>print( “Outs−>[0]” );
$Outs−>[1]−>print( “Outs−>[1]” );
$Outs−>[2]−>print( “Outs−>[2]” );

}

);

As shown in Table 8, Curr_Ins( ) returns an anonymous array of all input iflows. Curr_Outs( ) returns an anonymous array of all output iflows. Curr_State( ) returns the State root flow.

Table 9 illustrates the results of receiving and implementing the exemplary hardware code of Table 8 inside a code block of the Compute( ) construct, in accordance with one embodiment. Of course, it should be noted that the exemplary results shown in Table 9 are set forth for illustrative purposes only, and thus should not be construed as limiting in any manner.

TABLE 9

Ins−>[0] => (iflow)

n => 32

Ins−>[1] => (iflow)

n => 32

Outs−>[0] => (iflow)

max => 32

Outs−>[1] => (iflow)

which => 1

Outs−>[2] => (iflow)

Table 10 illustrates exemplary hardware code addressing multiple sets of input data flows within a Compute( ) construct, in accordance with one embodiment. Of course, it should be noted that the exemplary hardware code shown in Table 10 is set forth for illustrative purposes only, and thus should not be construed as limiting in any manner.

TABLE 10
my $In0 = aFlow

−>Hier_N( 4, [n => 32] )
−>Defer_Output( iflow_level => 1 );

my $In1 = aFlow

−>Hier_N( 4, [n => 32] )
−>Defer_Output( iflow level => 1 );

my( $Out0, $Out1 ) = $In0−>Compute(

name => “NV_compute_multiple_input_iflows”,
Others => [$In1],
Outs => [ [max => 32],

[which => 1] ],

out_reg => [1, 0],
out_fifo => [4, 0],
code => sub
{

my( $In0, $In1, $Out0, $Out1 ) = @_; # no state in this case,

would occur last

#----------------------------------------------------------------------------
# wait for both inputs to arrive then pick the max between the
two and
# indicate on $Out1 which was chosen.
#----------------------------------------------------------------------------
If $In0−>Valid( ) && $In1−>Valid( ) Then

my $Use1 = $In1−>{n} > $In0−>{n};
$Out0−>{max} <== $Use1 ? $In1−>{n} : $In0−>{n};
$Out1 −>{which} <== $Use1;

Else

#-----------------------------------------------------------------------
# stall an input if one arrived and the other didn't
#-----------------------------------------------------------------------
Stall $In0;
Stall $In1;

Endif
$In0−>print( “In0” );
$In1−>print( “In1” );
$Out0−>print( “Out0” );
$Out1−>print( “Out1” );

}

);

As shown in Table 10, $In0 and $In1 hold 4 sets of iflows each. Table 11 illustrates the results of receiving and implementing the exemplary hardware code of Table 10 inside a code block of the Compute( ) construct, in accordance with one embodiment. Of course, it should be noted that the exemplary results shown in Table 11 are set forth for illustrative purposes only, and thus should not be construed as limiting in any manner.

TABLE 11

In0 => (iflow)

n => 32

In1 => (iflow)

n => 32

Out0 => (iflow)

max => 32

Out1 => (iflow)

which => 1

In0 => (iflow)

n => 32

In1 => (iflow)

n => 32

Out0 => (iflow)

max => 32

Out1 => (iflow)

which => 1

In0 => (iflow)

n => 32

In1 => (iflow)

n => 32

Out0 => (iflow)

max => 32

Out1 => (iflow)

which => 1

In0 => (iflow)

n => 32

In1 => (iflow)

n => 32

Out0 => (iflow)

max => 32

Out1 => (iflow)

which => 1

As shown in Table 11, the code block sees one set at a time, and the code block is called back 4 times, one per set.

Additionally, in one embodiment, the hardware code components may include one or more hardware statements. For example, the hardware code components may include a “stall” hardware statement (e.g., “Stall,” etc.). For example, a Stall $In_Flow statement may be used to manually stall an input data flow for a current cycle.

Table 12 illustrates exemplary hardware code utilizing manual stalling within a Compute( ) construct, in accordance with one embodiment. Of course, it should be noted that the exemplary hardware code shown in Table 12 is set forth for illustrative purposes only, and thus should not be construed as limiting in any manner.

TABLE 12
my $In = aFlow

−>Hier( a => 32, b => 32 )
−>Defer_Output( );

my $Out = $In−>Compute(

name => “NV_compute_basic_transformation_manual_stalling”,
Out => [result => 33],
stallable => 0,
out_fifo => 16,
code => sub
{

my( $In, $Out ) = @_;
If $In−>Valid( ) Then

If $Out−>Ready( ) Then

$Out−>{result} <== $In−>{a} + $In−>{b};

Else

Stall $In;

Endif

Endif
$In−>print( “In” );
$Out−>print( “Out” );

}

);

As shown in Table 12, the Compute( ) construct is marked non-stallable. This means that the code block must manually check $Out->Ready( ) to ensure that it does't send a new packet when the output is backed up according to the innermost ready signal. Note that $Out->Ready( ) will not go to 0 until the 16-deep out_fifo is full. Also note that the out_fifo does not register its output in this case, but it will do a full 0-cycle bypass around any internal fifo ram. In this way, Stall may be used in conjunction with a Ready( ) hardware function to do manual stalling within the Compute( ) construct In one embodiment, for Compute( ) blocks with stallable=>1, input iflows may be automatically stalled if any output data flow is stalled. In this way, Stall may provide an additional way to stall an input iflow to avoid dropping input packets within the Compute( ) construct.

In another embodiment, the hardware code components may include an “if, then” hardware statement (e.g., “If . . . Then,” etc.) that conditionally performs one or more actions within the compute construct. Table 13 illustrates an exemplary “if, then” hardware statement within a Compute( ) construct, in accordance with one embodiment. Of course, it should be noted that the exemplary statement shown in Table 13 is set forth for illustrative purposes only, and thus should not be construed as limiting in any manner.

TABLE 13

If <bool> Then

<stmts>

Elsif <bool> Then

<stmts>

Else

<stmts>

Endif

In one embodiment, an “if, then” hardware statement may be combined with an “if, then” scripting language statement. Table 14 illustrates an exemplary “if, then” hardware statement within an if, then Perl statement within a Compute( ) construct, in accordance with one embodiment. Of course, it should be noted that the exemplary statement shown in Table 14 is set forth for illustrative purposes only, and thus should not be construed as limiting in any manner.

TABLE 14

```
if ( $perl_bool_var ) {
  If $In−>{val} < 3 Then
} else {
  If $In−>{val} == 5 Then
}
```

$Out−>{result} <== 20;

Endif

Additionally, in one embodiment, the system receiving the hardware code components may translate the “if, then” hardware statement into one or more aFlow method calls.

In another embodiment, the hardware code components may include a “given” hardware statement (e.g., “Given,” etc.) that conditionally performs one or more actions within the compute construct. Table 15 illustrates an exemplary “given” hardware statement within a Compute( ) construct, in accordance with one embodiment. Of course, it should be noted that the exemplary statement shown in Table 15 is set forth for illustrative purposes only, and thus should not be construed as limiting in any manner.

TABLE 15

Given $In−>{value}

When 0 Do

<stmts>

When 1 Do

<stmts>

When 2 .. 5, 7, 9 .. 10 Do

<stmts>

Default

<stmts>

EndGiven

In one embodiment, each “When” statement shown in Table 15 may contain a list of constant expressions composed in a scripting language (e.g., Perl, etc.). In another embodiment, scripting language “if” statements may be interspersed with parts of a “given” statement to allow macro construction of the “Given” and “When” hardware statements.

Additionally, in one embodiment, the hardware code components may include one or more looping hardware statements that allow one or more actions to be performed within the compute construct based on a given Boolean condition. In another embodiment, the looping hardware statements may be completely synthesizable and may not infer latches. In yet another embodiment, the looping hardware statements may translate into implicit state machines at compile time.

Further, in one example, the hardware code components may include a “while” hardware loop (e.g., “While,” etc.). In one embodiment, the “while” hardware loop may test a condition at the top of the loop. If it's still 1, it may execute the statements in the loop during the same cycle (unless it hits some kind of block within the loop, too). When it gets to the bottom of the loop, the “while” hardware loop may advance the state machine to a new state and execution may commence at the top of the loop the next cycle. In another embodiment, a Last statement may be used to break out of the loop this cycle. A Next statement may be used to jump back to the top of the loop the next cycle, which may be equivalent to jumping to the bottom of the loop this cycle. In yet another embodiment, the same state variable may be used for all of these statements.

Further still, in one embodiment, the hardware code components may include an “await” hardware loop (e.g., “Await,” etc.). For example, an Await <bool> statement may be functionally equivalent to “While !<bool> Do EndWhile.” In another embodiment, the hardware code components may include a “forever” hardware loop (e.g., “Forever,” etc.). For example, a Forever loop statement may be equivalent to “While I Do.” In yet another embodiment, the hardware code components may include a “forever” hardware loop (e.g., “Forever,” etc.). In one embodiment, a Compute code block may have an implicit Forever . . . EndForever around its statements. If such statements don't get blocked, then they may execute each cycle.

Table 16 illustrates exemplary looping hardware statements within a Compute( ) construct, in accordance with one embodiment. Of course, it should be noted that the exemplary statement shown in Table 16 is set forth for illustrative purposes only, and thus should not be construed as limiting in any manner.

TABLE 16

While <bool> Do

<stmts>
$Skip_to_top and Next;
<stmts>
$Done and Last;
<stmts>

EndWhile
Await <bool>;
Forever

<stmts>

EndForever
FSM
Idle:

<stmts>
$In−>Valid( ) and Goto State2;

State2:

<stmts>
$Done and Goto Idle;

EndFSM
For $I In <min_expr> .. <max_expr> Do

<stmts>

EndFor
Clock;
Clock 5;
Stop;
Exit 0;
Unblock;

As shown in Table 16, the While loop tests the <bool> condition at the top of the loop. If it's 0, “execution” may continue this cycle at the statements following the loop, thus completely skipping the loop body <stmts>. If the <bool> condition is 1, then the body of the loop <stmts> may be executed. When execution reaches the EndWhile, execution continues back at the top of the loop next cycle. All statements following the EndWhile may be blocked (i.e., disabled) during the execution of the loop. After the first iteration of the loop, statements before the While may also be blocked unless control transfers back to them in some other way (e.g., an outer loop, etc.).

Additionally, as shown in Table 16, the Next statement is used to continue at the top of the loop next cycle where the <bool> condition is re-evaluated. It thus behaves like EndWhile except it may occur in the middle of the loop body. Any statement in the body of the loop following the Next may be blocked during the current cycle. Further, the Last (or Last 1) statement is used to exit out of the loop next cycle, at which point, execution continues with statements following the EndWhile. Any statement in the body of the loop following the Last may be blocked during the current cycle. Further still, the Last 0 statement may be used to exit out of the loop during the current cycle.

Also, in one embodiment, the hardware code components may include a finite state machine hardware loop (e.g., “FSM,” etc.). For example, The FSM loop may include a Forever loop that has scripting-language labels denoting states and includes Goto statements for transitioning to the next state the next cycle. In another example, if no Goto is encountered in the current state, an implicit Goto <curr_state_label> may be added.

Table 17 illustrates an exemplary equivalent of a finite state machine hardware loop statement within a Compute( ) construct, in accordance with one embodiment. Of course, it should be noted that the exemplary statement shown in Table 17 is set forth for illustrative purposes only, and thus should not be construed as limiting in any manner.

TABLE 17
Forever
Idle:

| <stmts> | |
|---|---|
| $In−>Valid( ) and Goto State2; | # user-supplied |

| | |
|---|---|
| Goto Idle; | # this is added implicitly by FSM |

State2:

| <stmts> | |
|---|---|
| $Done and Goto Idle; | # user-supplied |

| | |
|---|---|
| Goto State2; | # this is added implicitly by FSM |

EndForever

Additionally, in one embodiment, the hardware code components may include a hardware “for” loop (e.g., “For $I In $Min . . . $Max do . . . EndFor,” etc.). For example, $I may implicitly uses something similar to the ‘=?’ latched assignment operator to start off with $Min during the current cycle, and may then iterate through the other values for subsequent cycles, all the while remembering $I if there are any other blocks inside the For loop body and while not inferring any actual latches during synthesis.

Table 18 illustrates an exemplary equivalent of a hardware “for” loop statement within a Compute( ) construct, in accordance with one embodiment. Of course, it should be noted that the exemplary statement shown in Table 18 is set forth for illustrative purposes only, and thus should not be construed as limiting in any manner. Also, in one embodiment, iteration may be performed in reverse.

TABLE 18
[allocate internal state variable $I_next]
my $I = <first_time_through_loop> ? $Min : $I_next;

| | |
|---|---|
| my $Max_latched =? $Max; | # evaluate $Max this cycle and |

“latch” result
While $I <= $Max_latched Do

If $I != $Max_latched Then

$I_next <== $I + 1;

EndIf
...
If $I == $Max_latched Do # any user-supplied ‘Next’ does this,
too

Last;

Endif

EndWhile

Further, in one embodiment, the hardware code components may include a clock hardware loop (e.g., “Clock $N,” etc.). For example, “Clock $N” may be equivalent to “For $I In 1 . . . $N Do EndFor.” More specifically, the clock hardware loop may just loop for $N cycles.

Further still, in one embodiment, the hardware code components may include a stop hardware statement (e.g., “Stop,” etc.). For example, the Stop statement may end a current (e.g., implicit, etc.) state machine and may effectively disable all statements controlled by the state machine. It may be equivalent to “Await 0.” Stop may put the state machine into a state that no other statements are enabled by. A status value may also be supplied for the debugger.

Also, in one embodiment, the hardware code components may include an exit hardware statement (e.g., “Exit,” etc.). For example, the Exit statement may cause a running simulation to end with a return status back to the operating system (O/S). In one embodiment, the simulation may be exited with a 0 status or a supplied status.

In addition, in one embodiment, the hardware code components may include an unblock hardware statement (e.g., “Unblock,” etc.). For example, the unblock hardware statement may decouple subsequent statements from previous ones. More specifically, it may create a new implicit state machine for subsequent statements. In another embodiment, when prior statements hit the Unblock, they may do an implicit Stop. In yet another embodiment, Unblock may occur anywhere inside statements, including If bodies, and may affect the behavior of statements after those If statements. In one embodiment, Unblock may be completely synthesizable by producing a new state variable for the statements inside the same Unblock area.

Table 19 illustrates an exemplary usage of an unblock hardware statement within a Compute( ) construct, in accordance with one embodiment. Of course, it should be noted that the exemplary statement shown in Table 19 is set forth for illustrative purposes only, and thus should not be construed as limiting in any manner.

TABLE 19
If $Bool0 Then

| | |
|---|---|
| Clock 5; | # normally blocks statements after it |

| | |
|---|---|
| Unblock; | # decouple from Clock 5, but not from $Bool0 |

$S−>{var} <== $S−>{var} + 1; # occurs in parallel with Clock 5

Endif

As shown in Table 19, the Unblock decouples the $S->{var} assignment from Clock 5, but both are still gated by $Bool0. The statements following the Endif are also unblocked by the Unblock. When the Clock 5 finishes, it effectively does a “Stop” when it hits the Unblock, but that implicit Stop does not affect the statements after the Unblock because they are decoupled and had proceeded in parallel 5 cycles earlier. In this way, the Unblock statement may decouple subsequent statements from prior statements in the same scope, and may create a new, parallel state machine for these statements. In another embodiment, the Unblock and the statements that follow may still be gated by any outer scopes.

Additionally, in one embodiment, the hardware code components may include one or more random number generator circuit functions. See, for example, U.S. patent application Ser. No. ______ (Attorney Docket No. NVIDP803/DU-12-0793), filed Mar. 15, 2013, which is hereby incorporated by reference in its entirety, and which illustrate exemplary random number generator circuit functions.

Further, in one embodiment, the hardware code components may include a hardware assertion statement (e.g., “Assert,” etc.). For example, the hardware code components may include an Assert hardware statement that kills a simulation when called from within the compute construct. In another example, the Assert hardware statement may be tied into a debugger, and when the debugger is called, it may take a user to the first assertion statement that fired and may highlight it in red. In yet another example, all user assertions may show up in the debugger and may be monitored by the debugger. In another embodiment, the Assert hardware statement may take a single bit Boolean flow expression as input.

Table 20 illustrates an exemplary usage of an assert hardware statement within a Compute( ) construct, in accordance with one embodiment. Of course, it should be noted that the exemplary statement shown in Table 20 is set forth for illustrative purposes only, and thus should not be construed as limiting in any manner.

TABLE 20

Assert <bool_expr>;

Further still, in one embodiment, the hardware code components may include a hardware print statement (e.g., “Printf,” etc.). In one embodiment, the Printf statement may be used to write out text strings to stdout during simulations. These Printf statements may also show up in the debugger (including the waveforms), so they may be a useful way to condense interesting information for debugging. In another embodiment, Printf may recognizes the entire usual formats %d, %h, etc. which may take build-time scripting-language values. In another embodiment, the Printf statement may add new %A and %a formats which may be used to format data flows. In still another embodiment, %A may write out values in hex: %a in decimal. A data flow passed to Printf may be an arbitrary hierarchy and %A or %a may automatically expand out the data flow (e.g., “a=>2, b=>5, c=>6”, etc.).

Table 21 illustrates an exemplary usage of a print hardware statement within a Compute( ) construct, in accordance with one embodiment. Of course, it should be noted that the exemplary statement shown in Table 21 is set forth for illustrative purposes only, and thus should not be construed as limiting in any manner.

TABLE 21

Printf “flow % d: % A\n”, $i, $Flow;

As shown in Table 21, Printf may include the hardware print statement that writes out information during a simulation to stdout. Table 22 illustrates hierarchical data flow within a print hardware statement, in accordance with one embodiment. Of course, it should be noted that the exemplary statement shown in Table 22 is set forth for illustrative purposes only, and thus should not be construed as limiting in any manner.

TABLE 22
For example, if a $Flow has leaf fields a, b, and c each of width 8, then:
Printf “flow => % A\n”, $Flow
may print the following out in the simulation stdout, where 326 is the current
Verilog ® $stime and NV_my_module is the Compute( ) module name:
(326) simTop.NV_my_module_Compute0: flow => [a => 8′h2a, b => 8′h33, c =>
8′h04]
whereas using % a in Perl may print out the following:
(326) simTop.NV_my_module_Compute0: flow => [a => 42, b => 51, c => 4]

Also, in one embodiment, the hardware code components may include one or more operators and methods. For example, the hardware code components may include a set of hardware operators and aFlow methods that may be used in code blocks for combinational expressions and assignment statements.

Additionally, in one embodiment, the hardware code components may include a hardware assignment operator. For example, a scripting language assignment operator (e.g., ‘=’) may be used within the hardware code to give a name to a data flow or subflow, and may not translate into any logic. This may be useful for creating shorthand. In another embodiment, code block input and output data flows may be similarly renamed from their originals passed into the Compute( ). Combinational expressions may also be assigned a variable name using the scripting language assignment operator.

Further, in one embodiment, to avoid conflicts with the scripting language, the hardware code components may include a hardware non-blocking assignment that may use ‘<==’ instead of ‘<=’ (less than) in order to avoid ambiguity in the scripting language. Any state or output data flow subflow may be assigned and structural copies may be allowed. Doing a non-blocking assign to any output data flow subflow may automatically cause a new output packet to be created for that output data flow. Unassigned subflows may have undefined values, possibly X's. X's may be allowed anywhere in data, but an assertion may be fired immediately if they indirectly propagate to any implicit clk, valid, or ready signals—this may happen, for example, if the creation of an output packet depends on some data subflows that happen to be X's.

Table 23 illustrates an exemplary usage of an assignment operator within a Compute( ) construct, in accordance with one embodiment. Of course, it should be noted that the exemplary statement shown in Table 23 is set forth for illustrative purposes only, and thus should not be construed as limiting in any manner.

TABLE 23

my $Y = $Flow−>{x}−>{y};

As shown in Table 23, ‘=’ is used for assigning a Perl variable as a reference to a data flow or part of a data flow. In one embodiment, wherever you use $Y it's as if you had typed $Flow->{x}->{y}. In this way, $Y may be used as a textural shorthand.

Further still, in one embodiment, the hardware code components may include a hardware combinatorial assignment operator (e.g., a hardware assignment operator that creates named references to combinatorial expressions). Table 24 illustrates an exemplary usage of a hardware combinatorial assignment operator, in accordance with one embodiment. Of course, it should be noted that the exemplary statement shown in Table 24 is set forth for illustrative purposes only, and thus should not be construed as limiting in any manner.

TABLE 24
Every combinational operator returns a reference to a new aFlow of appropriate
width:

| | |
|---|---|
| my $C = $A + $B; | # $C refers to the evaluated combinational expression $A + |

$B
If later, $C is overridden with something else, then a user may not be able to get
back to the $A + $B:
$C = ($C << 1) ∥ $Bit; # you've replaced $C with a reference to a new
combinational expression
The name need not be created with a “my”:

| | |
|---|---|
| $hash−>{C} = $A + $B; | # save it in a local Perl hash |

Also, in one embodiment, the hardware code components may include a hardware latched combinatorial assignment operator (e.g., ‘=?’, etc.). Table 25 illustrates an exemplary usage of a hardware latched combinatorial assignment operator within a Compute( ) construct, in accordance with one embodiment. Of course, it should be noted that the exemplary statement shown in Table 25 is set forth for illustrative purposes only, and thus should not be construed as limiting in any manner.

TABLE 25

| my $C =? $A + $B; # effectively “latch” it | |
|---|---|
| Clock 5; | # delay 5 clocks |

| | |
|---|---|
| my $D = $C + 1; | # $C still has $A + $B from above |

As shown in Table 25, there may be cases where a user would like to calculate a combinational expression and use it in the same cycle, then save it in flip-flops for subsequent statements after a blocking statement such as Clock, While, For, etc. When the hardware latched combinatorial assignment operator is enabled in the above statement, $C gets the new value of $A+$B. Otherwise, it gets the last computed value of $C when this statement was enabled. In one embodiment, flip-flops may be automatically inferred for the saved value of $C.

Additionally, in one embodiment, the hardware latched combinatorial assignment operator may act as a latch, but may not infer a latch in hardware. Instead, it may infer a conditional expression that chooses either the combinational expression if the assignment is enabled this cycle, or the saved value of that expression if the assignment is not enabled this cycle. So it may implement a latch using a ‘?:’ conditional ternary operator and an implicit save register. In another embodiment, the hardware latched combinatorial assignment operator may remember the combinational value for subsequent cycles.

Also, in one embodiment, the hardware code components may include one or more non-blocking assignment operators. Table 26 illustrates exemplary non-blocking assignment operators that may be used within a Compute( ) construct, in accordance with one embodiment. Of course, it should be noted that the exemplary non-blocking assignment operators shown in Table 26 are set forth for illustrative purposes only, and thus should not be construed as limiting in any manner. In one embodiment, every binary operator may have a plurality of corresponding assignment operators (e.g., three corresponding assignment operators, etc.).

TABLE 26

| Op | Example | Description | Prec | Assoc |
|---|---|---|---|---|
| <== | $Out−>{field} <== | Basic assignment of Out field or | 19 | right |
| | $Expr0; | State field. <== is used instead of <= | | |
| | | to avoid ambiguity. | | |
| <0= | $State−>{field} <0= | State variable assignment with reset | 19 | right |
| | $Expr0; | value of all 0's | | |
| <1= | $State−>{field} <1= | State variable assignment with reset | 19 | right |
| | $Expr0; | value of all 1's | | |
| Assign | Assign $State−>{field}, | State variable assignment with | 21 | nonassoc |
| | $Reset_Value, | arbitrary reset value | | |
| | $Expr0; | | | |
| +<== | $State−>{field} +<== | $State−>{field} <== $State−>{field} + | 19 | right |
| | $Expr0; | $Expr0 | | |
| +<0= | $State−>{field} +<0= | $State−>{field} <0= $State−>{field} + | 19 | right |
| | $Expr0; | $Expr0 | | |
| +<1= | $State−>{field} +<1= | $State−>{field} <1= $State−>{field} + | 19 | right |
| | $Expr0; | $Expr0 | | |

As shown in Table 26, non-blocking assignment operators may be used to assign Compute( ) state variables or Out iflows. In one embodiment, <== may be the only assignment operator that may be used for Out iflows and it's always used, regardless of out_reg, out_rdy_reg, out_fifo, etc. So if an Out iflow is not registered, <== ends up as a combinational assignment. Note that the values in Out iflows may never be read.

Also, in one embodiment, the hardware code components may include one or more bitslice and index operators. Table 27 illustrates exemplary bitslice and index operators that may be used within a Compute( ) construct, in accordance with one embodiment. Of course, it should be noted that the exemplary bitslice and index operators shown in Table 27 are set forth for illustrative purposes only, and thus should not be construed as limiting in any manner.

TABLE 27

| Op | Example | Out Width | Description |
|---|---|---|---|
| [<$msb: | $Expr[<10:3>] | $msb- | Bitslice. $Expr must be a leaf flow |
| $lsb>] | | $lsb + 1 | and msb and lsb must be constants. |
| | | | Note that the result always has an lsb |
| | | | starting at bit 0. To slice into a |
| | | | hierarchical flow, use {< $Expr >} to |
| | | | first convert it to a leaf flow. As( ) |
| | | | may also be used. |
| [<$msb\hat{ }: | $Expr[<10\hat{ }:3>] | $msb- | Equivalent to $Expr[<10-1:3>], This |
| $lsb >] | | $lsb | is a very common idiom in hardware |
| | | | design (width-1). |
| [<$msb: | $Expr[<10:\hat{ }3>] | $msb- | Equivalent to $Expr[<10:3-1>]. |
| \hat{ }$lsb>] | | $lsb | Less common. |
| [<$msb\hat{ }: | $Expr[<10\hat{ }:\hat{ }3>] | $msb- | Equivalent to $Expr[<10-1:3-1>]. |
| \hat{ }$lsb>] | | $lsb − 1 | Less common. |
| [<$index>] | $Expr[<$index>] | 1 (for | If $Expr is a leaf flow, then it's |
| | | leaf) | equivalent to |
| | | | $Expr[<$index:$index>]. If $Expr is |
| | | | a hierarchical flow with numeric |
| | | | fields, then $index can be a non- |
| | | | constant flow. When $index is a Perl |
| | | | scalar value, $Expr−>{$index} can be |
| | | | used. |

In one embodiment, a bitslice operator may takes a ‘msb:lsb’ format, but may have other versions for excluding the msb and/or lsb. This may be accomplished using ‘msb̂: lsb’, ‘msb:̂lsb’, or ‘msb̂: ̂lsb’. This may be convenient because often times a user may have the width of a field and may avoid typing ‘$width−1’ and just say, for example, ‘$widtĥ:0’ to exclude the $width bit.

Additionally, in another embodiment, an index operator may be used to conveniently reference a row in an Array( ) (ram) or a field of a numeric hierarchy data flow at hardware/simulation time. For reads, it may automatically infer a ram read or a Verilog® case statement. For assigns, it may automatically infer a ram write or Verilog® case statement of non-blocking assigns.

Furthermore, in one embodiment, the hardware code components may include one or more unary operators and methods. Table 28 illustrates exemplary unary operators and methods that may be used within a Compute( ) construct, in accordance with one embodiment. Of course, it should be noted that the exemplary unary operators and methods shown in Table 28 are set forth for illustrative purposes only, and thus should not be construed as limiting in any manner.

TABLE 28

| Op | Example | Out Width | Description | Prec | Assoc |
|---|---|---|---|---|---|
| Valid( ) | $In−>Valid( ) | 1 | test if input flow is valid this cycle | 1 | nonassoc |
| Ready( ) | $Out−>Ready( ) | 1 | test if output flow is ready this cycle | 1 | nonassoc |
| | | | (looks at innermost rdy signal) | | |
| As( ) | $Flow0−>As($Pkt) | $Pkt−>width( ) | takes the raw bits in $Flow and rewires | 1 | nonassoc |
| | | | them as a flow that is a Clone( ) of $Pkt | | |
| | | | (typically some other packet format); note | | |
| | | | that $Pkt can also be a simple number like | | |
| | | | 5 to treat $Flow as a Uint(5) leaf. It can | | |
| | | | also be an [name => width, . . . ] array. | | |
| | | | Basically anything that can be an input to | | |
| | | | Hier( ). Concatenation {< $Flow0 >} | | |
| | | | which is equivalent to $Flow−>As | | |
| | | | ($Flow0−>width( )) can also be used. If | | |
| | | | $Flow0 is smaller than $Pkt, then zero | | |
| | | | extension is performed; if $Flow0 is | | |
| | | | larger than $Pkt, then truncation is | | |
| | | | performed. As( ) may also be used outside | | |
| | | | of a code block because it's just wires. See | | |
| | | | As( ) for details. | | |
| Rand( ) | $Flow−>Rand( ) | $Flow−>Rand( ) | returns a random flow packet with the | 1 | nonassoc |
| | | | same format as $Flow; this is | | |
| | | | synthesizable; | | |
| Reversed( ) | $Expr0−>Reversed( ) | width0 | Returns $Expr0 bits reserved. | 1 | nonassoc |
| Num_Zeros( ) | $Expr0−>Num_Ones( ) | log2(width0) + 1 | Returns number of zero/one bits in | 1 | nonassoc |
| Num_Ones( ) | | | $Expr0. If $Expr0 is 0-bits-wide, then the | | |
| | | | result will be 0-bits-wide (implied 0 as | | |
| | | | well). Uses Sum( ) function below, which | | |
| | | | uses DW02_sum. | | |
| Is_One_Hot( ) | $Expr0−>Is_One_Hot( ) | 1 | Equivalent to: $Expr0−>Num_Ones( ) == | 1 | nonassoc |
| | | | 1 | | |
| Encoded_One_Hot( ) | $Expr0−>Encoded_One_Hot( ) | log2(width0) | Assumes that $Expr0 is a one-hot mask | 1 | nonassoc |
| | | | and returns the encoded bit position of the | | |
| | | | one-hot. If the number of one bits in the | | |
| | | | $Expr0 is not 1, then the result is | | |
| | | | undefined. Use Num_Trailing_Ones( ) if | | |
| | | | the number of one bits in the $Expr0 is | | |
| | | | not 1. | | |
| | | | For the inverse one-hot decode operation, | | |
| | | | use (1 << $Bit_Pos) to get a one-hot mask | | |
| | | | and infer efficient logic should be inferred | | |
| | | | by synthesis tools.. | | |
| Num_Leading_Zeros( ) | $Expr0−>Num_Lead- | log2(width0) | Returns number of leading zero/one bits | 1 | nonassoc |
| Num_Leading_Ones( ) | ing_Zeros( ) | | in $Expr0. If all the bits are zero/one, the | | |
| | | | result is undefined. However, when | | |
| | | | “full_count” is passed as an argument, an | | |
| | | | additional high-order bit will indicate if | | |
| | | | the count is full. | | |
| Num_Trailing_Zeros( ) | $Expr0−>Num_Trail- | log2(width0) | Returns number of trailing zero/one bits in | 1 | nonassoc |
| Num_Trailing_Ones( ) | ing_Zeros( ) | | $Expr0. If all the bits are zero/one, the | | |
| | | | result is undefined. If “full_count” is | | |
| | | | passed as an argument, an additional high- | | |
| | | | order bit will indicate if the count is full. | | |
| | | | Note that Num_Trailing_Zeros( ) is | | |
| | | | another way to ‘find first one’, i.e., it's a | | |
| | | | priority encoder. | | |
| | | | All four of these functions have O(logN) | | |
| | | | logic levels and O(N) area (they may use | | |
| | | | a leading zeroes detector component | | |
| | | | which uses a tree-based approach). | | |
| Log2( ) | $Expr0−>Log2( ) | log2(width0) + | Returns ceil(log2($Expr0)), which is | 1 | nonassoc |
| | | 1 | equivalent to: width0 − | | |
| | | | $Expr0−>Num_Leading_Zeros( ). | | |
| | | | If $Expr0 is 0, the results are thus undefined. | | |
| Is_Pow2( ) | $Expr0−>Is_Pow2( ) | 1 | Returns 1 if $Expr0 is a power-of-two, | 1 | nonassoc |
| | | | which is equivalent to $Expr0−>Is_One_Hot( ). | | |
| | | | (0 is not considered to be a power-of-2). | | |
| All_Ones( ) | $Expr0−>All_Ones( ) | 2\hat{ }(width0) − | Returns a bitmask of $Expr0 ones in the | 1 | nonassoc |
| | | 1 | lower bits. width0 must not be more than | | |
| | | | 10 right now. This may be implemented | | |
| | | | using (1 << $Expr0) − 1. | | |
| | | | Note that Const_All_Ones( ) may be used | | |
| | | | if the number of ones is known at build time. | | |
| ++ | $x++ | n/a | just showing precedence of Perl auto- | 3 | nonassoc |
| | | | increment operator (use +<== 1 for flows) | | |
| −− | $x−− | n/a | just showing precedence of Perl auto- | 3 | nonassoc |
| | | | decrement operator (use −<== 1 for flows) | | |
| ! | !$Flow0 | 1 | Logical NOT ($Flow0 must be 1-bit) | 5 | right |
| ~ | ~$Flow0 | width0 | Unary bitwise inversion | 5 | right |
| \| | \|$Flow0 | 1 | Unary OR | 5 | right |
| ~\| | ~\|$Flow0 | 1 | Unary NOR | 5 | right |
| & | &$Flow0 | 1 | Unary AND (unless it's before an | 5 | right |
| | | | identifier or ‘{’, in which case it's a | | |
| | | | subroutine name. It may be used in front | | |
| | | | of ‘{<’ which is not ‘{’) | | |
| ~& | ~&$Flow0 | 1 | Unary NAND | 5 | right |
| \hat{ } | \hat{ }$Flow0 | 1 | Unary XOR | 5 | right |
| ~\hat{ } | ~\hat{ }$Flow0 | 1 | Unary XNOR | 5 | right |
| abs etc. | abs $x | n/a | Perl named unary operators | 10 | nonassoc |
| not | not $x | 1 | Just like ‘!’, but lower precedence | 22 | right |

Further still, in one embodiment, the hardware code components may include one or more binary operators and methods. Table 29 illustrates exemplary binary operators and methods that may be used within a Compute( ) construct, in accordance with one embodiment. Of course, it should be noted that the exemplary binary operators and methods shown in Table 29 are set forth for illustrative purposes only, and thus should not be construed as limiting in any manner.

TABLE 29

| | | | | Has Assign | | |
|---|---|---|---|---|---|---|
| Op | Example | Out Width | Description | Ops? | Prec | Assoc |
| −> | $Flow−>{field} | $Flow−>{field}−>width( ) | just showing | no | 2 | left |
| | | | precedence of | | | |
| | | | Perl | | | |
| | | | dereference | | | |
| | | | operator | | | |
| | | | (doesn't | | | |
| | | | generate HW) | | | |
| ** | $x ** $y | n/a | just showing | no | 4 | nonassoc |
| | | | precedence of | | | |
| | | | Perl | | | |
| | | | exponentiation | | | |
| | | | operator (not | | | |
| | | | allowed for | | | |
| | | | flows) | | | |
| =~ | “string” =~ /\hat{ }\w + $/ | n/a | just showing | no | 6 | left |
| | | | precedence of | | | |
| | | | Perl pattern- | | | |
| | | | matching string | | | |
| | | | operator (not | | | |
| | | | allowed for | | | |
| | | | flows) | | | |
| !~ | “string” !~ /\hat{ }\w + $/ | n/a | just showing | no | 6 | left |
| | | | precedence of | | | |
| | | | Perl pattern- | | | |
| | | | not-matching | | | |
| | | | string operator | | | |
| | | | (not allowed | | | |
| | | | for flows) | | | |
| * | $Expr0 * | width0 + width1 | unsigned | yes | 7 | left |
| | $Expr1 | | multiply | | | |
| / | $x / $y | n/a | just showing | no | 7 | left |
| | | | precedence of | | | |
| | | | Perl divide | | | |
| | | | operator (not | | | |
| | | | allowed for | | | |
| | | | flows) | | | |
| % | $x % $y | n/a | just showing | no | 7 | left |
| | | | precedence of | | | |
| | | | Perl mod | | | |
| | | | operator (not | | | |
| | | | allowed for | | | |
| | | | flows) | | | |
| x | “#” x 80 | n/a | just showing | no | 7 | left |
| | | | precedence of | | | |
| | | | Perl string | | | |
| | | | repetition | | | |
| | | | operator (not | | | |
| | | | allowed for | | | |
| | | | flows, use “of” | | | |
| | | | instead) | | | |
| of | 3 of $Expr1 | 3 * $Expr1−>width( ) | Equivalent to | no | 7 | right |
| | | | returning the | | | |
| | | | list ($Expr1, | | | |
| | | | ($Expr1, | | | |
| | | | $Expr1). | | | |
| | | | Because it is | | | |
| | | | just a macro | | | |
| | | | that returns a | | | |
| | | | Perl list, | | | |
| | | | $Expr1 need | | | |
| | | | not be a flow. | | | |
| | | | Note that the | | | |
| | | | LHS and RHS | | | |
| | | | are evaluated | | | |
| | | | once each. In | | | |
| | | | contrast, Perl's | | | |
| | | | repetition | | | |
| | | | operator ‘x’, | | | |
| | | | works only for | | | |
| | | | strings. Count | | | |
| | | | is on the LHS. | | | |
| *& | $Expr0 * | width0 | unsigned | no | 7 | left |
| | $Expr1 | | multiply | | | |
| | | | truncated to | | | |
| | | | width of | | | |
| | | | $Expr0 | | | |
| + | $Expr0 + | max(width0, width1) + 1 | 2's complement | yes | 8 | left |
| | $Expr1 | | add | | | |
| − | $Expr0 − | max(width0, width1) + 1 | 2's complement | yes | 8 | left |
| | $Expr1 | | sub | | | |
| +& | $Expr0 +& | width0 | 2's complement | no | 8 | left |
| | $Expr1 | | add, truncated | | | |
| | | | to width of | | | |
| | | | $Expr0 | | | |
| −& | $Expr0 −& | width0 | 2's complement | no | 8 | left |
| | $Expr1 | | sub, truncated | | | |
| | | | to width of | | | |
| | | | $Expr0 | | | |
| << | $Expr0 << | width0 + (2**width1 − 1) | left shift | yes | 9 | left |
| | $Expr1 | | | | | |
| <<& | $Expr0 <<& | width0 | left shift, | no | 9 | left |
| | $Expr1 | | truncated to | | | |
| | | | width of | | | |
| | | | $Expr0 | | | |
| >> | $Expr0 >> | width0 | unsigned right | yes | 9 | left |
| | $Expr1 | | shift | | | |
| rol | $Expr0 <<< | width0 | rotate left | yes | 9 | left |
| | $Expr1 | | | | | |
| ror | $Expr0 >>> | width0 | rotate right | yes | 9 | left |
| | $Expr1 | | | | | |
| <= | $Expr0 <= | 1 | unsigned less | no | 11 | nonassoc |
| | $Expr1 | | than or equals | | | |
| >= | $Expr0 >= | 1 | unsigned | no | 11 | nonassoc |
| | $Expr1 | | greater than or | | | |
| | | | equals | | | |
| < | $Expr0 < | 1 | unsigned less | no | 11 | nonassoc |
| | $Expr1 | | than | | | |
| > | $Expr0 > | 1 | unsigned | no | 11 | nonassoc |
| | $Expr1 | | greater than | | | |
| == | $Expr0 == | 1 | Equals | no | 12 | nonassoc |
| | $Expr1 | | | | | |
| != | $Expr0 != | 1 | Not equals | no | 12 | nonassoc |
| | $Expr1 | | | | | |
| === | $Expr0 === | 1 | 4-state equals | no | 12 | nonassoc |
| | $Expr1 | | (synthesizes as | | | |
| | | | ‘==’) | | | |
| !== | $Expr0 !== | 1 | 4-state not | no | 12 | nonassoc |
| | $Expr1 | | equals | | | |
| | | | (synthesizes as | | | |
| | | | ‘!=’) | | | |
| & | $Expr0 & | min(width0, width1) | Bitwise AND | yes | 13 | left |
| | $Expr1 | | | | | |
| ~& | $Expr0 ~& | max(width0, width1) | Bitwise NAND | yes | 13 | left |
| | $Expr1 | | | | | |
| \| | $Expr0 \| | max(width0, width1) | Bitwise OR | yes | 14 | left |
| | $Expr1 | | | | | |
| ~\| | $Expr0 ~\| | max(width0, width1) | Bitwise NOR | yes | 14 | left |
| | $Expr1 | | | | | |
| \hat{ } | $Expr0 \hat{ } | max(width0, width1) | Bitwise XOR | yes | 14 | left |
| | $Expr1 | | | | | |
| ~\hat{ } | $Expr0 ~\hat{ } | max(width0, width1) | Bitwise XNOR | yes | 14 | left |
| | $Expr1 | | | | | |
| && | $Expr0 && | 1 | logical AND | yes | 15 | left |
| | $Expr1 | | ($Expr0 and | | | |
| | | | $Expr1 must be | | | |
| | | | 1-bit) | | | |
| !&& | $Expr0 !&& | 1 | logical NAND | yes | 15 | left |
| | $Expr1 | | (ditto) | | | |
| ∥ | $Expr0 ∥ | 1 | Logical OR | yes | 16 | left |
| | $Expr1 | | (ditto) | | | |
| !∥ | $Expr0 !∥ | 1 | Logical NOR | yes | 16 | left |
| | $Expr1 | | (ditto) | | | |
| \hat{ }\hat{ } | $Expr0 \hat{ }\hat{ } | 1 | Logical XOR | yes | 16 | left |
| | $Expr1 | | (ditto) | | | |
| !\hat{ }\hat{ } | $Expr0 !\hat{ }\hat{ } | 1 | Logical XNOR | yes | 16 | left |
| | $Expr1 | | (ditto) | | | |
| .. | $a .. $b | n/a | just showing | no | 17 | nonassoc |
| | | | precedence of | | | |
| | | | Perl range | | | |
| | | | operator (not | | | |
| | | | currently | | | |
| | | | allowed for | | | |
| | | | flows) | | | |
| , | $x, $y | n/a | just showing | no | 20 | left |
| | | | precedence of | | | |
| | | | comma | | | |
| | | | operator | | | |
| => | name => | n/a | just showing | no | 20 | left |
| | $val | | precedence of | | | |
| | | | comma | | | |
| | | | operator | | | |
| and | $Expr0 and | void (1 if $Expr0 is | if $Expr0 is an | no | 23 | nonassoc |
| | $State−>{field} <== | not an aFlow) | aFlow, | | | (left if |
| | $Expr1; | | preparser | | | $Expr0 is |
| | | | replaces it with: | | | not an |
| | | | If $Expr0 Then | | | aFlow) |
| | | | $State−>{field} <== | | | |
| | | | $Expr1; Endif | | | |
| or | $Expr0 or | void (1 if $Expr0 is | if $Expr0 is an | no | 24 | nonassoc |
| | $State−>{field} <== | not an aFlow) | aFlow, | | | (left if |
| | $Expr1; | | preparser | | | $Expr0 is |
| | | | replaces it with: | | | not an |
| | | | If !$Expr0 | | | aFlow) |
| | | | Then $State−>{field} <== | | | |
| | | | $Expr1; Endif | | | |
| xor | $Expr0 xor | 1 | same as ‘\hat{ }\hat{ }’, | no | 24 | left |
| | $Expr1 | | but lower | | | |
| | | | precedence; | | | |
| | | | unlike ‘and’ and | | | |
| | | | ‘or’, does not | | | |
| | | | short-circuit | | | |

Also, in one embodiment, the hardware code components may include one or more N-ary operators and methods. See, for example, U.S. patent application Ser. No. ______ (Attorney Docket No. NVIDP802/DU-12-0792), filed Mar. 15, 2013, which is hereby incorporated by reference in its entirety, and which describes exemplary N-ary operators and methods.

Additionally, in one embodiment, the hardware code components may include an As( ) function that may be used to map the data contents of any interface flow to a completely different format of larger or smaller size. In this way, a data packet can be easily mapped to one of various packet formats.

Further, in one embodiment, the hardware code components may include one or more empty input and output data flows. For example, code blocks may fire off an empty output packet on a data flow by assigning 0 to it. The constant 0 (without a width specifier) has width 0, so assigning 0 to any empty data flow or subflow may not require that the subflow have anything in it. A named field may similarly have zero width. This may be useful in designs to keep a name of a subflow around in the data flows as a convenience so that code may look the same in all configurations, without actually consuming any area or logic to service it. It's simply a zero-width subflow and its value may always be 0. Thus it may be referenced in combinational expressions where it yields the value 0.

Further still, in one embodiment, the hardware code components may include one or more System Verilog® and scripting-language operators and numeric literals.

In this way, the Compute( ) block may be instantiated anywhere in a hardware design and the modules may be automatically created. In one embodiment, each unique Compute( ) may have its own code block.

Further, as shown in operation 208, the compute construct is incorporated into the integrated circuit design in association with the one or more data flows. In one embodiment, the one or more data flows may be passed into the compute construct, where they may be checked at each stage. In another embodiment, bugs may be immediately found and the design script may be killed immediately upon finding an error. In this way, a user may avoid reviewing a large amount of propagated errors. In yet another embodiment, the compute construct may check that each input data flow is an output data flow from some other construct or is what is called a deferred output.

For example, a deferred output may include an indication that a data flow is a primary design input or a data flow will be connected later to the output of some future construct. In another embodiment, it may be confirmed that each input data flow is an input to no other constructs. In yet another embodiment, each construct may create one or more output data flows that may then become the inputs to other constructs. In this way, the concept of correctness-by-construction may be promoted. In still another embodiment, the constructs are also superflow-aware. For example, some constructs may expect superflows, and others may perform an implicit ‘for’ loop on the superflow's subflows so that the user does't have to.

Furthermore, in one embodiment, a set of introspection methods may be provided that may allow user designs and generators to interrogate data flows. For example, the compute construct may use these introspection functions to perform their work. More specifically, the introspection methods may enable obtaining a list of field names within a hierarchical data flow, widths of various subflows, etc. In another embodiment, in response to the introspection methods, values may be returned in forms that are easy to manipulate by the scripting language.

Further still, in one embodiment, the compute construct may include constructs that are built into the hardware description language and that perform various data steering and storage operations that have to be built into the language. In another embodiment, the constructs may be bug-free (i.e., already verified) as an incentive for the user to utilize them as much as possible.

Also, in one embodiment, the compute construct contains one or more parameters. For example, the compute construct may contain a “name” parameter that indicates a base module name that will be used for the compute construct and which shows up in the debugger. In another embodiment, the compute construct may contain a “comment” parameter that provides a textual comment that shows up in the debugger. In yet another embodiment, the compute construct may contain a “stallable” parameter that indicates whether automatic flow control is to be performed within the construct (e.g., whether input data flows are to be automatically stalled when outputs aren't ready, etc.). For example, if the “stallable” parameter is 0, the user may use various data flow methods such as Valid( ) and Ready( ), as well as a Stall statement to perform manual flow control.

Additionally, in one embodiment, the compute construct may contain an out_fifo parameter that allows the user to specify a depth of the output FIFO for each output data flow. For example, when multiple output data flows are present, the user may supply one depth that is used by all, or an array of per-output-flow depths. In another embodiment, the compute construct may contain an out_reg parameter that causes the output data flow to be registered out. For example, the out_reg parameter may take a 0 or 1 value or an array of such like out_fifo.

Further, in one embodiment, the compute construct may contain an out_rdy_reg parameter that causes the output data flow's implicit ready signal to be registered in. This may also lay down an implicit skid flip-flop before the out_reg if the latter is present. In another embodiment, out_fifo, out_reg, and out_rdy_reg may be mutually exclusive and may be used in any combination.

Further still, in one embodiment, clocking and clock gating may be handled implicitly by the compute construct. For example, there may be three levels of clock gating that may be generated automatically: fine-grain clock gating (FGCG), second-level module clock gating (SLCG), and block-level design clock gating (BLCG). In another embodiment, FGCG may be handled by synthesis tools. In yet another embodiment, a per-construct (i.e., per-module) status may be maintained. In still another embodiment, when the status is IDLE or STALLED, all the flip-flops and rams in that module may be gated. In another embodiment, the statuses from all the constructs may be combined to form the design-level status that is used for the BLCG. This may be performed automatically, though the user may override the status value for any Compute( ) construct using the Status <value> statement.

Also, in one embodiment, a control construct may be incorporated into the integrated circuit design in association with the compute construct and the one or more data flows. For example, an output data flow from the control construct may act as an input data flow to the compute construct, or an output data flow from the compute construct may act as an input data flow to the control construct. See, for example, U.S. patent application Ser. No. ______ (Attorney Docket No. NVIDP800/DU-12-0790), filed Mar. 15, 2013, which is hereby incorporated by reference in its entirety, and which describes exemplary compute constructs.

FIG. 3 shows an exemplary hardware design environment 300, in accordance with one embodiment. As an option, the environment 300 may be carried out in the context of the functionality of FIGS. 1-2. Of course, however, the environment 300 may be implemented in any desired environment. It should also be noted that the aforementioned definitions may apply during the present description.

As shown, within a design module 302, reusable component generators 304, functions 306, and a hardware description language embedded in a scripting language 308 are all used to construct a design that is run and stored 310 at a source database 312. Also, any build errors within the design are corrected 344, and the design module 302 is updated. Additionally, the system backend is run on the constructed design 314 as the design is transferred from the source database 312 to a hardware model database 316.

Additionally, the design in the hardware model database 316 is translated into C++ or CUDA™ 324, translated into Verilog® 326, or sent directly to the high level GUI (graphical user interface) waveform debugger 336. If the design is translated into C++ or CUDA™ 324, the translated design 330 is provided to a signal dump 334 and then to a high level debugger 336. If the design is translated into Verilog® 326, the translated design is provided to the signal dump 334 or a VCS simulation 328 is run on the translated design, which is then provided to the signal dump 334 and then to the high level GUI waveform debugger 336. Any logic bugs found using the high level GUI waveform debugger 336 can then be corrected 340 utilizing the design module 302.

FIG. 4 illustrates an exemplary system 400 in which the various architecture and/or functionality of the various previous embodiments may be implemented. As shown, a system 400 is provided including at least one host processor 401 which is connected to a communication bus 402. The communication bus 402 may be implemented using any suitable protocol, such as PCI (Peripheral Component Interconnect), PCI-Express, AGP (Accelerated Graphics Port), HyperTransport, or any other bus or point-to-point communication protocol(s). The system 400 also includes a main memory 404. Control logic (software) and data are stored in the main memory 404 which may take the form of random access memory (RAM).

The system 400 also includes input devices 412, a graphics processor 406 and a display 408, i.e. a conventional CRT (cathode ray tube), LCD (liquid crystal display), LED (light emitting diode), plasma display or the like. User input may be received from the input devices 412, e.g., keyboard, mouse, touchpad, microphone, and the like. In one embodiment, the graphics processor 406 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user. The system may also be realized by reconfigurable logic which may include (but is not restricted to) field programmable gate arrays (FPGAs).

The system 400 may also include a secondary storage 410. The secondary storage 410 includes, for example, a hard disk drive and/or a removable storage drive, representing a floppy disk drive, a magnetic tape drive, a compact disk drive, digital versatile disk (DVD) drive, recording device, universal serial bus (USB) flash memory, etc. The removable storage drive reads from and/or writes to a removable storage unit in a well-known manner.

Computer programs, or computer control logic algorithms, may be stored in the main memory 404 and/or the secondary storage 410. Such computer programs, when executed, enable the system 400 to perform various functions. Memory 404, storage 410 and/or any other storage are possible examples of computer-readable media.

In one embodiment, the architecture and/or functionality of the various previous figures may be implemented in the context of the host processor 401, graphics processor 406, an integrated circuit (not shown) that is capable of at least a portion of the capabilities of both the host processor 401 and the graphics processor 406, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 400 may take the form of a desktop computer, laptop computer, server, workstation, game consoles, embedded system, and/or any other type of logic. Still yet, the system 400 may take the form of various other devices m including, but not limited to a personal digital assistant (PDA) device, a mobile phone device, a television, etc.

Further, while not shown, the system 400 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
identifying a plurality of scripting language statements and a plurality of hardware language statements;
identifying one or more hardware code components within the plurality of hardware language statements; and
creating the compute construct, utilizing the identified one or more hardware code components and the plurality of scripting language statements.

2. The method of claim 1, wherein the one or more hardware code components include one or more hardware functions.

3. The method of claim 1, wherein the one or more hardware code components include one or more of a Curr_Ins( ) function that retrieves all input data flows for the compute construct as an array, a Curr_Outs( ) function that retrieves all output data flows for the compute construct as an array, and a Curr_State( ) function that retrieves a state flow for the compute construct.

4. The method of claim 1, wherein the one or more hardware code components include one or more hardware functions for interrogating data flows from inside of a code block.

5. The method of claim 1, wherein the one or more hardware code components includes one or more of a Valid( ) function that determines whether an input data flow for the compute construct has a valid input, a Ready( ) function that determines whether the output data flow for the compute construct can accept new output, a Status( ) function that determines a status of the output data flow for the compute construct, and a Transferred( ) function that tests whether an output data flow for the compute construct is transferring out of the compute construct for a particular cycle.

6. The method of claim 1, wherein the one or more hardware code components include one or more hardware statements.

7. The method of claim 1, wherein the one or more hardware code components include one or more of a Stall statement that manually stalls an input data flow for the compute construct for one cycle, an If, Then statement that conditionally performs one or more actions within the compute construct, and a Given statement that conditionally performs one or more actions within the compute construct.

8. The method of claim 1, wherein the one or more hardware code components include one or more synthesizable blocking statements that allow one or more actions to be performed within the compute construct based on a given Boolean condition or looping range.

9. The method of claim 1, wherein the one or more hardware code components include one or more statements that trigger a synthesizable random number generator.

10. The method of claim 1, wherein the one or more hardware code components include an Assert statement that stops a hardware design simulation if a Boolean expression is met within the compute construct.

11. The method of claim 1, wherein the one or more hardware code components include a Printf statement that outputs one or more strings from the compute construct during a hardware design simulation and automatically expands data flows.

12. The method of claim 1, wherein the one or more hardware code components include one or more hardware operators.

13. The method of claim 1, wherein the one or more hardware code components include one or more of a combinational assignment operator, a latched combinational assignment operator, and a non-blocking assignment operator.

14. The method of claim 1, wherein the one or more hardware code components include one or more of a bitslice operator and an index operator.

15. The method of claim 1, wherein the one or more hardware code components include one or more of a unary operator, a binary operator, and an N-ary operator.

16. The method of claim 1, wherein the plurality of scripting language statements and the plurality of hardware language statements are identified within a code block associated with a development of the compute construct.

17. The method of claim 1, wherein the compute construct includes one or more of a name parameter that indicates a name for the compute construct, a comment parameter that provides a textual comment that appears in a debugger when debugging a design, a stallable parameter that indicate whether automatic flow control is to be performed within the compute construct, a parameter used to specify a depth of an output queue for each output data flow of the compute construct, a parameter that causes an output data flow of the compute construct to be registered out, and a parameter that causes a ready signal of an output data flow of the compute construct to be registered in.

18. The method of claim 1, wherein the data flow includes a superflow, and the computer program product is operable such that one or more of the control constructs performs automatic looping on a plurality of subflows of the superflow.

19. A computer program product embodied on a computer readable medium, comprising:
code for identifying a plurality of scripting language statements and a plurality of hardware language statements;
code for identifying one or more hardware code components within the plurality of hardware language statements; and
code for creating the compute construct, utilizing the identified one or more hardware code components and the plurality of scripting language statements.

20. A system, comprising:
a processor for identifying a plurality of scripting language statements and a plurality of hardware language statements, identifying one or more hardware code components within the plurality of hardware language statements, and creating the compute construct, utilizing the identified one or more hardware code components and the plurality of scripting language statements.
